(19) United States
(12) Patent Application Publication
(10) Pub. No.: US 2024/0119424 A1
(43) Pub. Date: Apr. 11, 2024

(54) DISASTER DETECTION AND RECOVERY

(71) Applicant: VIVINT, INC., Provo, UT (US)

(72) Inventors: AMANDA LOFVERS, Orlando, FL (US); ANTHONY FARNSWORTH, Alpine, UT (US)

(73) Assignee: VIVINT, INC., Provo, UT (US)

(21) Appl. No.: 18/484,421

(22) Filed: Oct. 10, 2023

Related U.S. Application Data
(60) Provisional application No. 63/414,288, filed on Oct. 7, 2022.

(51) Int. Cl. G06Q 10/20; G06Q 40/08

(52) U.S. Cl. CPC G06Q 10/20; G06Q 40/08

(57) ABSTRACT

Apparatuses, methods, systems, and program products are disclosed for disaster detection and recovery. An apparatus includes at least one sensor unit of a home automation system, a processor, and a memory that stores code executable by the processor. The code is executable by the processor to cause the apparatus to detect a disaster event using data captured by the at least one sensor unit, determine a type of the disaster event based on the captured data, identify at least one repair service provider associated with the determined type of disaster event, and initiate contact with the at least one repair service provider for performing repairs associated with the disaster event.

### CROSS REFERENCE TO RELATED APPLICATIONS

This application claims the benefit of U.S. Provisional Patent Application No. 63/414,288 entitled “DISASTER DETECTION AND RECOVERY” and filed on Oct. 7, 2022, for Amanda Lofvers, et al., which is incorporated herein by reference.

### FIELD

This invention relates to home automation systems and the use of a home automation system to detect and recover from a disaster.

### BACKGROUND

Disaster events such as water leaks, fires, wind damage, or the like may occur without warning. Recovering from such a disaster can be an expensive and timely process that involves various parties including the property owner, the insurance carrier, and various repair service providers.

### BRIEF SUMMARY

An apparatus for disaster detection and recovery is disclosed. A system and method also perform the functions of the apparatus.

In one embodiment, an apparatus includes at least one sensor unit of a home automation system, a processor, and a memory that stores code executable by the processor. In one embodiment, the code is executable by the processor to cause the apparatus to detect a disaster event using data captured by the at least one sensor unit, determine a type of the disaster event based on the captured data, identify at least one repair service provider associated with the determined type of disaster event, and initiate contact with the at least one repair service provider for performing repairs associated with the disaster event.

In one embodiment, a method includes detecting a disaster event using data captured by at least one sensor unit, determining a type of the disaster event based on the captured data, identifying at least one repair service provider associated with the determined type of disaster event, and initiating contact with the at least one repair service provider for performing repairs associated with the disaster event.

In one embodiment, an apparatus includes means for detecting a disaster event using data captured by at least one sensor unit, means for determining a type of the disaster event based on the captured data, means for identifying at least one repair service provider associated with the determined type of disaster event, and means for initiating contact with the at least one repair service provider for performing repairs associated with the disaster event.

### BRIEF DESCRIPTION OF THE DRAWINGS

Specific embodiments of the invention are illustrated in the following drawings, which depict only embodiments of the invention and should not therefore to be considered to limit its scope.

FIG. 1 illustrates an example of one embodiment of a system for disaster detection and recovery in accordance with the subject matter disclosed herein.

FIG. 2 is a schematic block diagram illustrating one embodiment of an apparatus for disaster detection and recovery in accordance with the subject matter disclosed herein.

FIG. 3 is a schematic block diagram illustrating one embodiment of a method for disaster detection and recovery in accordance with the subject matter disclosed herein.

FIG. 4 is a schematic block diagram illustrating one embodiment of a method for disaster detection and recovery in accordance with the subject matter disclosed herein.

### DETAILED DESCRIPTION

Aspects of the present invention are described herein with reference to system diagrams, flowchart illustrations, and/or block diagrams of methods, apparatuses, systems, and computer program products according to embodiments of the invention. It will be understood that blocks of the flowchart illustrations and/or block diagrams, and combinations of blocks in the flowchart illustrations and/or block diagrams, can be implemented by computer readable program instructions.

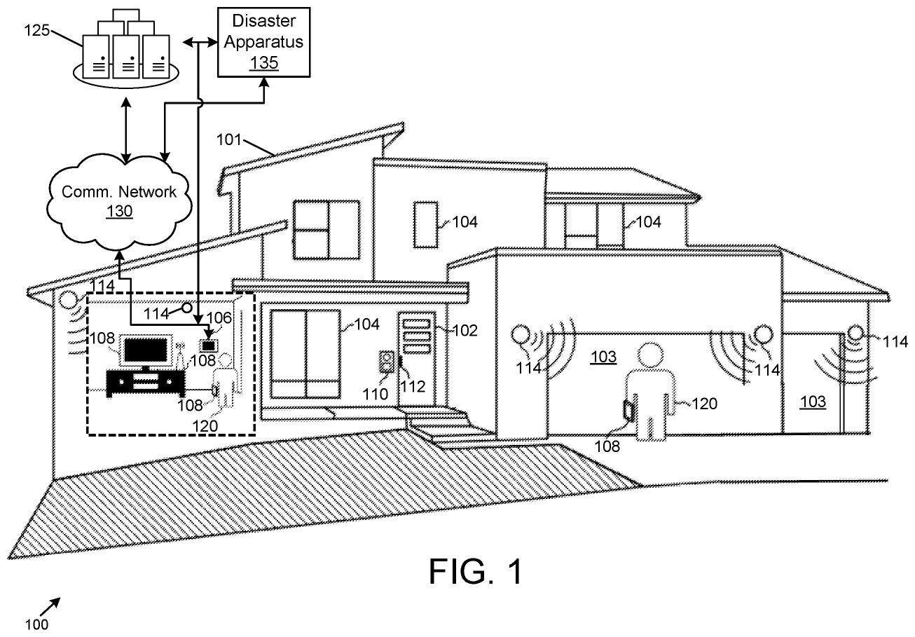

FIG. 1 depicts a diagram illustrating one example of an environment 100 in which the present systems and methods may be implemented. In some embodiments, the systems described herein may include a building automation system, which may include an interconnection of one or more controllers 106, sensors 114, computing devices 108, smart devices 108, 110, 112, and/or the like, which are described in more detail below. The environment 100 may include a building 101 such as a home, office, warehouse, garage, and/or the like. The environment 100 may include various entryways, such as doors 102, garage doors 103, and/or windows 104.

The building automation system may include any number of devices. Devices within the building automation system may be communicatively coupled to each other through a set of wired and/or wireless communication links. This communication may be accomplished, for example, via a connection to a network 130, such as a local network, the Internet, or the like. The devices may communicate with a central server or a cloud computing system. The devices may form a mesh network. When the devices are connected to a common network, the building automation system may be an Internet of Things (“IoT”) system.

The devices of the building automation system may include, for example, devices such as data collection devices, computing devices, output devices, servers, or appliances. Devices of the building automation system may operate in various sub-systems. Sub-systems of the building automation system may include, but are not limited to, security; heating, ventilation, and air conditioning (“HVAC”); lighting; electrical; fire control; and energy management systems. For example, a building automation system may include a security subsystem of devices such as cameras, entry point sensors, or smart locks. A system may additionally or alternatively include an HVAC subsystem of devices such as thermostats, temperature sensors, fans, and heaters.

In some embodiments, the environment 100 may include a structure 101 such as a building. Such a structure 101 may include a residence, a commercial or industrial building, an outdoor area, or any combination thereof. The environment 100 may include a portion of the structure 101 or the entire structure 101. Thus, the structure 101 may include devices that are not part of the building automation system. Although the environment 101 of the building automation system may include a structure 101, the building automation system may nonetheless be communicatively coupled to devices located outside of the structure 101.

The environment 100 may be divided into one or more zones. For example, a temperature setting may be employed for one room of a house that is different than that of another room of the house. In such an example, the building automation system may designate the first room as being in a particular zone to provide customized settings for that room in particular.

In some embodiments, the environment 100 may include a home, and the building automation system may be a home automation system. The building automation system may include a plurality of components. These components may include, but are not limited to, devices such as controllers 106, control panels, servers, computing devices 108 (e.g., personal computers or mobile devices), displays, gateways, cameras, processors, data collection devices, automation/security devices, devices with memory, alarm devices with audio and/or visual capabilities, sensors 114, HVAC devices (e.g., thermostats, fans, heaters, or the like), appliances, interface devices, smart switches, speakers, doorbells 110, smart locks 112, and/or the like. Each of these components may be integrated with other components. For example, a camera may be integrated with a doorbell 110 to provide video footage of a person ringing the doorbell 110.

The devices may be intelligent, multi-sensing, network-connected devices that can integrate with each other and/or with a central server of a cloud-computing system in communication with the building automation system. The building automation system may provide automatic, centralized control of these devices. As such, the building automation system may provide automatic, centralized control of the building's sub-systems, such as the security, HVAC, building management, electrical, or lighting systems.

One or more devices of the building automation system may include data collection or user input capabilities. In some embodiments, these devices may be implemented to determine different behaviors of a user 120 within or immediately outside of the environment. These devices may include, but are not limited to, sensors 114, cameras, tracking devices, feedback mechanisms, interfaces, switches, and microphones.

The building automation system may also include several devices capable of both collecting and outputting data through user interfaces. These interfaces may be accessed by the user 120 through an application configured for access through the web, a mobile device, and/or a tablet. A user 120 may also access them via a terminal or control panel mounted to a wall within the home or to a piece of furniture. A control panel may interface with a network through a first set of wired and/or wireless communication links.

Such interface devices may include, for example, one or more thermostats or interfaces placed at entryways. For example, entryway interfaces may include “smart doorbells” equipped with a sensor such as a camera, touch, or motion sensor. Entryway interfaces may detect a person's entry into or departure from the premises.

The building automation system may include other data collection devices such as devices that measure usage. For example, such devices may include those that measure energy usage, water consumption, or energy generation.

In some embodiments, the building automation system may be a home security system. In such an embodiment, the building automation system may prevent, detect, deter, or mitigate the effects of intrusions, crimes, natural disasters, or accidents occurring within the environment 100. The building automation system may carry out these functions in accordance with predetermined preferences of a user 120.

The building automation system may detect a potential intruder through one or more of its devices. The presence of a potential intruder may be communicated to one or more additional devices. The building automation system may do this by monitoring areas that are outside of the home or even outside of the environment 100. The building automation system can include interfaces that communicate such threats to a user 120. Detection devices of the building automation system may also communicate these threats to a device of the system capable of relaying the message to a user 120. For example, messages may be received by the user 120 from the building automation system through one or more mobile devices.

A building automation system embodied as a security system may include, but is not limited to, security devices such as smart locks, cameras, sensors 114, alarm devices, lighting, speakers, and garage door controls. The building automation system may provide automated, centralized control of such devices.

The building automation system may include devices with both hardware and software components. For example, the building automation system may include a smart lock that has hardware components with the capability to lock or unlock a door and software components with the capability to receive instructions from a mobile device through an application.

The building automation system may include emergency response capabilities. For example, the building automation system may be connected to a cellular, radio, or computer network that serves to notify authorities and/or emergency personnel when a crime, natural disaster, or accident has occurred within the home. In some embodiments, building automation system may communicate directly with authority and/or emergency services in such an event. The building automation system may be monitored by an offsite monitoring service. The offsite monitoring service include personnel who can receive notifications of and/or monitor events taking place within the environment 100 contact emergency services when sign of such an event appear.

The building automation system may include a controller 106 that is configured to control one or more components of the building automation system. The controller 106 may be any suitable computing device. The controller 106 may include both software and hardware components. For example, the controller 106 may include a processor, a user interface, a means of remote communication (e.g., a network interface, modem, gateway, or the like), a memory, a sensor, and/or an input/output port. The memory of the controller 106 may include instructions executable to perform various functions relating to automation and control of the building automation system. In some embodiments, the controller 106 may communicate with other components of the building automation system over a common wired or wireless connection. The controller 106 may also communicate to outside networks, such as the Internet.

The controller 106 may be part of, integrated with, and/or in communication with a control panel, an IoT or smart device (e.g., a light bulb, a light switch, a doorbell 110, a smart lock 112, or the like), a sensor 114, a computing device 108, a remote computer 125 and/or server, and/or another electronic device. In some embodiments, the controller 106 may be integrated with and/or in communication with a remote service such as a remote computer 125 and/or server. For example, the controller 106 may be located remotely to the environment 100, or the like. The controller 106 may cause components of the building automation system to perform various actions based on input received from the user 120 and/or on a certain setting. The controller 106 can cause various components of the building automation system to perform certain actions based on the occurrence of certain events. In some embodiments, the controller 106 can also receive instructions from a remote service provider. For example, if a remote service provider receives a notification that an intrusion has been detected within a home, the controller 106 may implement instructions from the remote service provider to activate various alarms within the home.

In some embodiments, the controller 106 may include several physical inputs. A user 120 may enter information using these inputs. Inputs may include, for example, devices such as keypads, keyboards, touch screens, buttons, switches, microphones, cameras, motion sensors, or any combination thereof. A user 120 may input data manually via, for example, a control panel, mobile computing device, desktop computing device, navigation system, gaming system, or appliance (e.g., television, HVAC, and the like). A user 120 may also input data or select controls via one or more data collection devices. For example, a user 120 may provide input via a microphone that they plan to leave the premises. The microphone can then communicate that information to the controller, which can then implement the appropriate settings based on that information. This may involve, for example, communicating with a smart lock device to lock a door. The user 120 may also provide input with instructions for the system to carry out a certain task. In that case, the controller 106 may directly influence an appropriate component of the building automation system to carry out that task. For example, if the user 120 provides an instruction to “turn the lights off,” the controller 106 can communicate those instructions to a smart light switch.

The controller 106 may also include an output display. This display may show the status of the building automation system or of various components of the building automation system. In some embodiments, the output display may be part of a graphical user interface (“GUI”) through which the building automation system may also receive inputs from the user 120. The display and/or interface of the controller 106 may provide information to the user 120.

In some embodiments, the controller 106 may communicate with one or more devices, servers, networks, or applications that are external to the building automation system. For example, the controller 106 may communicate with external devices through a cloud computing network. In some embodiments, these devices may process data received through one or more components of the building automation system. The external devices may also connect to the Internet and support an application on a mobile or computing device through which a user 120 can connect to their building automation system.

Other devices of the building automation system can also allow a user 120 to interact with the building automation system even if they are not in physical proximity to the environment 100 or any of the devices within the building automation system. For example, a user 120 may communicate with a controller 106 or another device of the building automation system using a computer (e.g., a desktop computer, laptop computer, or tablet) or a mobile device (e.g., a smartphone). A mobile or web application or web page may receive input from the user 120 and to communicate with the controller 106 to control one or more devices of the building automation system. Such a page or application may also communicate information about the device's operation to the user 120. For example, a user 120 may be able to view a mode of an alarm device of the building automation system and may change operational status of the device through the page or application.

In some embodiments, the controller 106 may be a computing device located in the environment 100. For example, the controller 106 may be a personal computer, a laptop, a desktop computer, a server, or any combination thereof.

The controller 106 can be a standalone device. For example, the controller 106 may be a smart speaker, speech synthesizer, virtual assistant device, or any combination thereof. The controller 106 may also be a control panel. The control panel may include a GUI to receive inputs from the user 120 and display information. The physical components of the control panel may be fixed to a structure within the environment 100. For example, a control panel including the controller 106 may be mounted to a wall of a home. A control panel may also be mounted to a piece of furniture. The controller 106 may also be a mobile and/or handheld device.

In certain embodiments, the controller 106 may be located remotely from the building automation system. For example, the controller 106 may control components of the building automation system from a location of a service provider. The functions of the controller 106 may include functions that involve changing a status of a component of the building automation system or causing a component of the building automation system to perform a certain action.

The controller 106 can allow a user 120 to change a status or mode of the building automation system. For example, for a building automation system that has alarm and security capabilities, the user 120 can use the controller 106 to change the status of the premises from “armed” to “disarmed” or vice versa. Other examples of statuses of the building automation system that can be affected through the controller 106 include, but are not limited to, “armed but at home,” “armed stay,” “armed and away,” “away,” “at home,” “sleeping,” “large gathering,” “nanny mode,” and/or “cleaning company here.” These statuses may reflect a user's preferences for how the building automation system should operate while that status is activated.

The user 120 may also be able to view the status of the building automation system or of one or more components of the system through a display of the controller 106. Alternatively or additionally, the controller may be able to communicate the status of the system to the user 120 through such means as audio outputs, lighting elements, messages and/or notifications transmitted to a mobile device of a user 120 (through an application, for example), or any combination thereof. The controller 106 can transmit messages or notifications to the user 120 regarding the status of one or more components of the system.

The controller 106 may allow a user 120 to control any component of the building automation system. For example, the user 120 may activate an automated vacuum, fan element, lighting element, camera, sensor, alarm, or any combination thereof through the controller 106. The user 120 may also add components to the building automation system through the controller 106. For example, if the user 120 purchases a new fan that they would like to integrate into the building automation system, they may do so by making inputs and/or selections through the controller 106.

The user 120 may also use the controller 106 to troubleshoot problems with the building automation system or components of the system. For example, if a heating element of a building automation system does not appear to be functioning properly, the user 120 may obtain a diagnosis of the problem by answering questions through the controller 106. Through the controller 106, the user 120 may provide instructions to take certain actions in response to a component of a system not functioning properly. In some embodiments, the user 120 may also communicate with one or more service providers through the controller 106. For example, the controller 106 may relay instructions to a device of the building automation system that is connected to a network to send a message to a service provider requesting a service to repair a malfunctioning component of the building automation system.

Through the controller 106, the user 120 may change or set up schedules for the building automation system. For example, the user 120 may desire that the premises be kept below a certain temperature at night and above a certain temperature during the day. Thus, the user 120 may create a schedule for the building automation system that reflects these preferences through the controller 106.

In some embodiments, the initial setup/configuration of the building automation system may be done through the controller 106. For example, when a building automation system is first implemented or installed within the premises, the user 120 may user 120 the controller 106 to add and connect each component of the building automation system and to setup or configure their preferences. All or part of the configuration and initial setup process may be done automatically by the controller 106. For example, when a new component of the building automation system is detected, that component may be added to the building automation system automatically through the controller 106.

The controller 106 may monitor one or more components of the building automation system. The controller 106 may also track and/or store data and/or information related to the building automation system and/or operation of the sys building automation system. For example, the controller 106 may store data and/or information in a memory of the controller and/or in memory at one or more devices of the building automation system. This data/information can include, for example, user 120 preferences, weather forecasts, timestamps of entry to and departure from a structure, user 120 interactions with a component of the building automation system, settings, and other suitable data and information. The controller 106 may track and/or store this data automatically or in response to a request received from a user 120.

In one embodiment, the controller 106 may be communicatively coupled to one or more computing devices. The computing devices may include one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In one embodiment, the computing devices include applications (e.g., mobile applications), programs, instructions, and/or the like for controlling one or more features of the controller 106. The computing devices, for instance, may be configured to send commands to the controller 106, to access data stored on or accessible via the controller 106, and/or the like. For example, a smart phone may be used to view photos or videos of a building via the controller 106, to view or modify temperature settings via the controller 106, and/or the like. In such an embodiment, the controller 106 may include an application programming interface (“API”), or other interface, for accessing various features, settings, data, components, elements, and/or the like of the controller 106, and the building automation system in general.

The building automation system, in one embodiment, includes one or more sensors 114 that are communicatively coupled to the controller 106. As used herein, sensors 114 may be devices that are used to detect or measure a physical property and record, indicate, or otherwise respond to it. Examples of sensors 114 that may be part of the building automation system may include motion sensors, temperature sensors, pressure sensors, light sensors, entry sensors such as window or door sensors that are used to detect when a window or door (or other entryway) is open or closed, carbon monoxide detectors, smoke detectors, water leak sensors, microphones and/or other audio sensors used to detect and/or differentiate sounds such as breaking glass, closing doors, music, dialogue, and/or the like, infrared sensors, cameras, and/or the like.

In one embodiment, the building automation system may include various cameras that are located indoors and/or outdoors and are communicatively coupled to the controller 106. The cameras may include digital cameras, video cameras, infrared cameras, and/or the like. The cameras may be mounted or fixed to a surface or structure such as a wall, ceiling, soffit, and/or the like. The cameras may be moveable such that the cameras are not fixed or secured to a surface or structure, but can be moved (e.g., a baby monitor camera).

In one embodiment, devices may include multiple sensors 114 or a combination of sensors 114. For example, a smart doorbell may include an integrated camera, a light sensor, and a motion sensor. The light sensor may be used to configure camera settings of the camera, e.g., for light or dark image capture, and the motion sensor may be used to activate the camera, to send a notification that a person is at the door, and/or the like in response to the detected motion. Furthermore, the doorbell may include a physical button to activate a wired or wireless chime within the building, a notification or sound from a mobile application associated with the doorbell, and/or the like.

In one embodiment, a camera, a controller 106, a local and/or remote computing device 125, a mobile device, and/or the like, may include image processing capabilities for analyzing images, videos, or the like that are captured with the cameras. The image processing capabilities may include object detection, facial recognition, gait detection, and/or the like. For example, the controller 106 may analyze or process images from a camera, e.g., a smart doorbell, to determine that a package is being delivered at the front door/porch. In other examples, the controller 106 may analyze or process images to detect a child walking within a proximity of a pool, to detect a person within a proximity of a vehicle, to detect a mail delivery person, to detect animals, and/or the like. In certain embodiments, the controller 106 may utilize artificial intelligence and machine learning image processing methods for processing and analyzing image and/or video captures.

In one embodiment, the controller 106 is connected to various IoT devices. As used herein, an IoT device may be a device that includes computing hardware to connect to a data network and communicate with other devices to exchange information. In such an embodiment, the controller 106 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In one embodiment, the controller 106 may poll, request, receive, or the like information from the IoT devices (e.g., status information, health information, power information, and/or the like) and present the information on a display on the controller 106, via a mobile application, and/or the like.

In one embodiment, the IoT devices include various lighting components includes smart light fixtures, smart light bulbs, smart switches, smart outlets, exterior lighting controllers, and/or the like. For instance, the controller 106 may be communicatively connected to one or more of the various lighting components to turn lighting devices on/off, change different settings of the lighting components (e.g., set timers, adjust brightness/dimmer settings, adjust color settings, and/or the like). In further embodiments, the various lighting settings may be configurable using a mobile applications, via the controller 106, running on a smart device.

In one embodiment, the IoT devices include one or more speakers within the building. The speakers may be stand-alone devices such as speakers that are part of a sound system, e.g., a home theatre system, a doorbell chime, a Bluetooth speaker, and/or the like. In certain embodiments, the one or more speakers may be integrated with other devices such as televisions, lighting components, camera devices (e.g., security cameras that are configured to generate an audible noise or alert), and/or the like.

In one embodiment, the various components of the building automation system, e.g., the controller 106, cameras and other devices, IoT devices, and/or the like, are communicatively connected over wired or wireless links of a communication network 130. The communication network 130, in one embodiment, includes a digital communication network that transmits digital communications. The communication network 130 may include a wireless network, such as a wireless cellular network, a local wireless network, such as a Wi-Fi network, a Bluetooth® network, a near-field communication (“NFC”) network, an ad hoc network, and/or the like. The communication network 130 may include a wide area network (“WAN”), a storage area network (“SAN”), a local area network (“LAN”) (e.g., a home network), an optical fiber network, the internet, or other digital communication network. The communication network 130 may include two or more networks. The communication network 130 may include one or more servers, routers, switches, and/or other networking equipment. The communication network 130 may also include one or more computer readable storage media, such as a hard disk drive, an optical drive, non-volatile memory, RAM, or the like.

The wireless network may be a mobile telephone network. The wireless network may also employ a Wi-Fi network based on any one of the Institute of Electrical and Electronics Engineers (“IEEE”) 802.11 standards. Alternatively, the wireless network may include a Bluetooth® connection. In addition, the wireless network may employ Radio Frequency Identification (“RFID”) communications including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In one embodiment, the wireless network may employ a ZigBee® connection based on the IEEE 802 standard. In such an embodiment, the wireless network includes a ZigBee® bridge. In one embodiment, the wireless network employs a Z-Wave® connection as designed by Sigma Designs®. Alternatively, the wireless connection may employ an ANT® and/or ANT+® connection as defined by Dynastream® Innovations Inc. of Cochrane, Canada.

In one embodiment, the building automation system is configured to provide various functions via the connections between the different components of the building automation system. In one embodiment, the building automation system may automate various routines and processes. The routines may be learned over time, e.g., based on the occupancy of user 120s, the activities of user 120s, and/or the like, and/or may be programmed or configured by a user 120 (e.g., via a digital automation platform such as If This Then That (“IFTTT”)).

For example, the building automation system may automate a “wake-up routine” for a user 120. The “wake-up routine” may define a process flow that includes starting a coffee maker, activating a water heater and/or turning on a bath/shower faucet, turning up the temperature in the building via a thermostat, triggering automated blinds/window coverings to open, turning on a television and setting it to a particular channel, and/or activating/deactivating/changing settings of lights. In such an embodiment, the process flow may be defined using an interface on the controller 106 and/or via a mobile application, and the controller 106 may coordinate communications, including instructions, commands, or signals, via a data network, to trigger different functions of the IoT devices that are included in the process flow.

The building automation system may also be configured to react to different triggers or signals. For example, a building automation system may include water leak detection and prevention components that include water leak sensors and/or a IoT device that is configured to shut off water at the main water line into the building (e.g., a smart valve that is connected to the water main, a device that is configured to actuate the shut-off valve at the water main, and/or the like). In such an embodiment, the controller 106 may receive a signal from a water leak detection sensor and may send a signal, command, instruction, or the like to the water main shut off valve to shut off the water into the building. In one embodiment, the water leak sensor may include multiple different contact points, e.g., at different levels, heights, or the like, to determine different severities of a water leak, e.g., to determine a depth, a leak rate, or the like.

In another example, the building automation system may include a smart irrigation controller that is configured to control one or more water valves and/or other components of an outdoor irrigation system (e.g., a home sprinkler system). The controller 106 may be communicatively connected to the smart irrigation controller over a data network to control various irrigation settings, automatically or in response to user 120 input. For example, a moisture sensor may detect that it is raining during or at the same time that the smart irrigation controller is configured to begin watering. In response to detecting the rain, the controller 106 may communicate with the smart irrigation controller to cancel the irrigation, to adjust the water output (e.g., based on the amount of rain that is detected), and/or the like. In some embodiments, the controller 106 may communicate with the smart irrigation controller to adjust the irrigation schedule, to delay the current irrigation (e.g., if the forecast indicates that the rain will stop within a period of time), and/or the like.

In one embodiment, the building automation system may be configured to perform various smart home functions, e.g., automated functions to assist a user 120 within a home. For example, an entry sensor on a front door that the controller 106 is communicatively connected to may detect that the door is opened, indicating the presence of a person within the home. In response to the front door sensor indicating the presence of a person, the controller 106 may trigger one or more lights, e.g., via a smart light switch and/or a smart light fixture/bulb, to turn on.

In another example, one or more entry sensors may indicate that doors and/or windows are opened frequently, which may cause the loss of heated or cooled air and/or may introduce particulates into the air within the home. Accordingly, in response to the indication from the one or more entry sensors, the controller 106 may change settings of the HVAC system (e.g., increase the volume of the HVAC system, change the temperature or humidity settings of the HVAC system, and/or the like), and may activate an air purifier within the home.

In another example, the controller 106 may receive a notification from a user's smart phone that the user 120 is within a predefined proximity or distance from the home, e.g., on their way home from work. Accordingly, the controller 106 may activate a predefined or learned comfort setting for the home, including setting a thermostat at a certain temperature, turning on certain lights inside the home, turning on certain lights on the exterior of the home, turning on the television, turning a water heater on, and/or the like.

In one embodiment, the building automation system may be configured to perform various security functions, e.g., automated functions to detect, monitor for, and/or deter the presence of an unauthorized person or activity. For example, a motion detection sensor may detect movement outside a home. In response to the motion detection, the controller 106 may activate one or more cameras that are within a proximity of the motion detection sensor to capture images and/or videos of the detected movement. The controller 106 may use image processing techniques to process the captured images/videos to determine if the detected movement is a person, and, if so, may try to identify the person. If the controller 106 cannot identify the person, or if the person is identified as an unauthorized person, the controller 106 may trigger various enhanced security measures to deter and/or react to the security threat.

For example, the controller 106 may communicate with one or more smart lighting devices to activate one or more interior and/or exterior lights. In another example, the controller 106 communicates with one or more speaker devices to generate a sound such as a whistle, alarm, of the like. In such an embodiment, sounds may be generated within the home to simulate occupancy of the home, e.g., sounds such as people talking, music, television sounds, water running, glass breaking, kids playing, and/or the like. Other sounds may be generated outside the home to simulate outdoor activities, e.g., sounds such as tools clanking or other garage noises, people walking outside, and/or the like.

The controller 106, in further embodiments, may send notifications, alerts, and/or other messages to designated persons/parties to indicate the potential security threat. For example, the controller 106 may send a push notification, text message, social media message, email message, voice message, and/or the like to an owner of the home, to emergency services, e.g., police department, and/or the like. In one embodiment, the controller 106 may include details associated with the potential security threat including a timestamp, images/videos of the person, the location (e.g., the address), and/or the like.

In one embodiment, the disaster apparatus 135 is configured to detect a disaster event based on data captured using the sensors 114, determine a type of the disaster, e.g., a water leak, and perform a response action in response to the disaster event, e.g., notify a user, connect a user with a disaster response service or their insurance carrier, as described in more detail below.

In certain embodiments, the disaster apparatus 135 may include a hardware device such as a secure hardware dongle or other hardware appliance device (e.g., a set-top box, a network appliance, or the like) that attaches to a device such as a head mounted display, a laptop computer, a server, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); or the like. A hardware appliance of the disaster apparatus 135 may include a power interface, a wired and/or wireless network interface, a graphical interface that attaches to a display, and/or a semiconductor integrated circuit device as described below, configured to perform the functions described herein with regard to the disaster apparatus 135.

The disaster apparatus 135, in such an embodiment, may include a semiconductor integrated circuit device (e.g., one or more chips, die, or other discrete logic hardware), or the like, such as an FPGA or other programmable logic, firmware for an FPGA or other programmable logic, microcode for execution on a microcontroller, an ASIC, a processor, a processor core, or the like. In one embodiment, the disaster apparatus 135 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the disaster apparatus 135.

The semiconductor integrated circuit device or other hardware appliance of the disaster apparatus 135, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the disaster apparatus 135 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

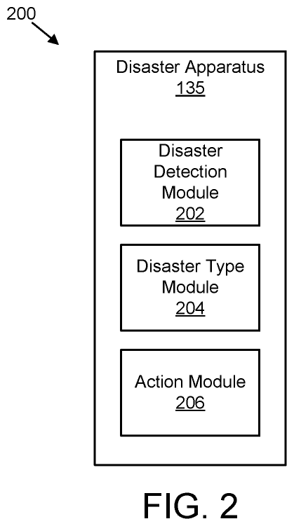

FIG. 2 depicts one embodiment of an apparatus 200 for disaster detection and recovery. In one embodiment, the apparatus 200 includes an embodiment of a disaster apparatus 135. The disaster apparatus 135, in one embodiment, includes one or more of a disaster detection module 202, a disaster type module 204, and an action module 206, which are described in more detail below.

In one embodiment, the disaster detection module 202 is configured to detect a disaster event using data captured by the at least one sensor unit. As used herein, a disaster event may be an event that causes damage, or has the potential to cause damage, to an area or a structure such as a home, garage, office, yard, and/or the like. For example, a disaster event may include a water leak, a fire, a strong wind event (e.g., hurricane, tropical storm, tornado, or the like), a hailstorm, flooding, and/or the like.

In one embodiment, the disaster detection module 202 may detect a disaster, or potential disaster, based on data from the sensor units 110. For instance, the disaster detection module 202 may detect unusually high water usage levels or may receive data directly from a water leak sensor, and/or the like, which may be indicative of a water leak. In another example, the disaster detection module 202 may detect smoke based on data from a smoke alarm or may detect unusually high temperatures based on temperature data from a thermostat or other temperature sensor, and/or the like, which may be indicative of a fire.

In one embodiment, the disaster type module 204 determines a type of the detected disaster event based on the captured data. In such an embodiment, the disaster type module 204 may analyze, process, or the like the captured data to determine the disaster type. For example, the disaster type module 204 may compare or cross-reference the captured date to predetermined data that is known to be associated with a particular disaster type, may use machine learning or artificial intelligence to analyze the captured data to estimate or predict the disaster type, and/or the like.

For instance, as described above, the captured data may include image data, video data, audio data, environmental data (e.g., moisture data, wind data, temperature data, or the like) and/or the like, and the disaster type module 204 may analyze the data to determine that the captured data indicates a water leak, a fire, wind damage, and/or the like. The disaster type module 204 may further determine additional details associated with the detected disaster event such as the location of the disaster, e.g., a location of a structure (e.g., an address, GPS location, or the like), a location within a structure (e.g., a bedroom, a utility room, or the like), a location of the sensors 114 that captured the data that triggered the disaster event, and/or the like.

In further embodiments, the disaster detection module 202 and/or the disaster type module 204 may query one or more other sensors 114 for captured sensor data to confirm the disaster event based on data captured by the one or more other sensors 114. The other sensors 114 may include sensors 114 closest or proximate to the sensors 114 that captured the data that triggered the disaster event, other similar sensor types (e.g., other water leak sensors, smoke alarms, and/or the like), and/or the like.

In one embodiment, the action module 206 is configured to perform at least one response action in response to the disaster event based on the determined type of the disaster event. In one embodiment, the at least one response action may include generating and sending a notification for the disaster event. In such an embodiment, the notification may include an electronic notification such as a text message, an email, a push notification (e.g., to a mobile application executing on the user's device, to a control panel or smart hub associated with a home automation and/or security system, or the like), an instant message, a social media message, and/or the like. In certain embodiments, the notification may include an automated voice call (e.g., with a voice bot or with a real person), a recording, or the like.

In one embodiment, the notification may include educational diagnosis information to diagnose and remedy the disaster event. For instance, if the disaster event comprises a water leak, the notification may include educational materials such as surveys, flow charts, walk throughs, manuals, instructional videos, links to customer support webpages or online documentation, and/or the like to walk the user through the steps of diagnosing the water leak and attempting to correct or fix the leak.

For instance, a text notification may include links to self-help, do-it-yourself videos, guides, walkthroughs, and/or the like for remedying the disaster event. For example, the action module 206, based on the determined disaster type, may search or reference online sources, a database of predetermined content, and/or the like to identify relevant videos or other content for helping the user to correct, fix, or otherwise remedy the disaster situation. The action module 206 may provide educational information as part of a post-disaster follow up. For example, a day, a week, or the like after a disaster event, the action module 206 may identify resources, materials, or the like, to educate the user on preventative measures to avert a future disaster, or the like.

In one embodiment, the notification includes contact information for a repair service provider of a preferred repair network associated with an insurance carrier, e.g., a home insurance company. For instance, the action module 206 may identify the user's insurance carrier, e.g., based on the user's profile/account information associated with the home automation system, or the like, and may identify one or more repair service providers that are within the insurance carrier's network, that are preferred repair service providers for the insurance carrier, and/or the like.

For instance, the action module 206 may search or reference an insurance carrier's policy, website, a database, or the like (e.g., via an internet search, via an API, or the like) to determine an insurance carrier's preferred repair service provider list, to determine repair service providers that are within the insurance carrier's network, and/or the like. In one embodiment, the action module 206 may access a database or data store of an insurance carrier, a home automation or security provider/company (e.g., Vivint, Inc.), and/or the like to determine the preferred repair service providers (e.g., based on the type of disaster, based on the homeowner's insurance policy, based on the sensor data, or the like).

The action module 206 may then determine the contact information for the preferred repair service providers, e.g., based on information from the insurance carrier (e.g., accessible via an API, or the like), based on information queried from the Internet (e.g., from an online directory), based on information scraped from a website (e.g., a repair service provider's website), and/or the like. The action module 206 may automatically initiate communications or otherwise contact the repair service provider using the repair service provider information on behalf of the user, e.g., may automatically initiate a phone call, a text message, an online chat with a user or a chat bot, or the like, and transfer the communication to the user at some point during the communication. For example, the action module 206 may initiate a voice conversation with a repair service provide and at some point during the voice conversation transfer the voice conversation to the user (e.g., via the user's device). In one embodiment, the action module 206 customizes the initial and subsequent messages/communications with the repair service provider based on a severity of the disaster, based on the type of disaster, and/or the like. For example, the initial communications may include an urgency message if the disaster is severe whereas a less severe emergency may not wound as urgent.

In one embodiment, the action module 206 provides the repair service provider information to the user and provide means for contacting the repair service provider, e.g., providing a hyperlink to the repair service provider's online emergency form, a link to call the repair service provider's emergency phone number, a link to initiate an online chat, and/or the like, to schedule repair services for fixing, repairing, correcting, or the like the disaster event. In one embodiment, the action module 206 provides the user with the option to contact the repair service provider via a graphical user interface, e.g., of a mobile application, in a web browser, or the like. In such an embodiment, the action module 206 may present interactive graphical elements that the user can tap or otherwise select to initiate communications with a repair service provider, e.g., to initiate a voice call, a text message, a chat or instant message, send an email, or the like.

In one embodiment, the action module 206 determines the user's location or the location of the disaster event, e.g., based on location information from the user's device, from the control panel of the user's home automation system, and/or the like, and identifies repair service providers that are within a predetermined distance of the user's location, which may be particularly useful in an emergency situation. The action module 206 may use a combination of the insurance carrier's preferred repair service providers and the user's location to identify repair service providers that the insurance carrier provides and that are within a predetermined distance of the user.

In one embodiment, the action module 206 is configured to prepopulate an electronic form for the repair service provider and/or the insurance carrier with the user's information without the user's input or intervention. For instance, the action module 206 may fill in the user's contact information, insurance information, description of the disaster, and/or the like, based on the user's account/profile information accessed from the user's device, from the home automation system, and/or the like. In some embodiments, the action module 206 includes multimedia content such as videos, images, audio, or the like associated with the disaster event as captured by the sensors 114 in the form. In this manner, contact forms, information forms, and/or other electronic forms can be completed as much as possible in an efficient, accurate, and timely manner.

In one embodiment, the action module 206 generates a notification that includes a plurality of questions that are presented to the user to determine or assess the extent, level, or the like of the disaster event and to assist in remedying the disaster. For instance, the action module 206 may present a text message from a chat bot, or other automated system, that the user can respond to and interact with to diagnose and remedy the disaster event, e.g., “A water leak has been detected in the laundry room. Please confirm”. In one embodiment, the notification includes instructions or steps for the user to perform to remedy the disaster where a subsequent step is presented to the user based on the user's response to a previous step.

For example, the action module 206 may trigger a text message from a text bot for a water leak. In such an example, the first text may be to confirm that there is a water leak. Upon confirmation from the user, the next text may then be to determine the location of the water leak, and then to determine potential causes of the water leak within the location (e.g., if in a utility room, the water leak may be due to a leak in the water heater, water softener, or the like), and so on. The text bot may recommend different repair service providers to the user and automatically contact the repair service providers in response to the user's confirmation or may automatically contact a preferred repair service provider from the user's insurance carrier without user confirmation or input. In one embodiment, the action module 206 may automatically transfer or connect the user with a customer service representative for the repair service provider and/or the user's insurance carrier.

In one embodiment, the action module 206 may send follow-up texts at some predetermined time after the disaster is diagnosed, corrected, repaired, or the like. For instance, the action module 206 may initiate a text or voice conversation to confirm that the disaster occurred, to confirm a type of disaster, to determine or confirm that the disaster was recovered, whether the user needs additional help or assistance, whether the user would like to review the repair service provider that assisted with the disaster, and/or the like.

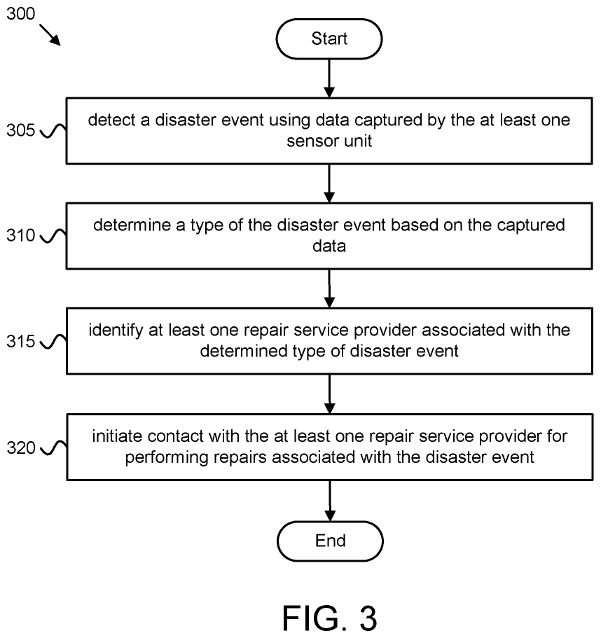

FIG. 3 depicts one embodiment of a method 300 for disaster detection and recovery. In one embodiment, the method 300 is performed at least in part by a controller 106, such as a smart hub or a control panel of a home automation system, by a sensor 114, by a disaster apparatus 135, by a user's device, by a mobile application, and/or another computing device.

In one embodiment, the method 300 begins and detects 305 a disaster event using data captured by at least one sensor unit 114. In one embodiment, the method 300 determines 310 a type of the disaster event based on the captured data. In one embodiment, the method 300 identifies 315 at least one repair service provider associated with the determined type of disaster event. In one embodiment, the method 300 initiates 320 contact with the at least one repair service provider for performing repairs associated with the disaster event, and the method 300 ends.

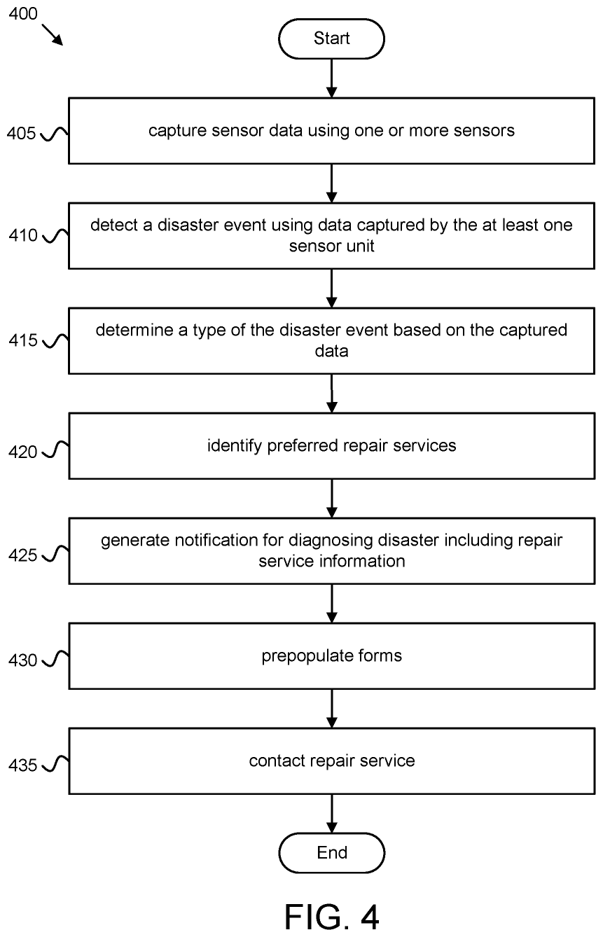

FIG. 4 depicts one embodiment of a method 400 for disaster detection and recovery. In one embodiment, the method 400 is performed at least in part by a controller 106, such as a smart hub or a control panel of a home automation system, by a sensor 114, by a disaster apparatus 135, by a user's device, by a mobile application, and/or another computing device.

In one embodiment, the method 400 begins and captures 405 sensor data using one or more sensors 114. In one embodiment, the method 400 detects 410 a disaster event using data captured by at least one sensor unit 114. In one embodiment, the method 400 determines 415 a type of the disaster event based on the captured data.

In one embodiment, the method 400 identifies 420 a preferred repair service provider based on the user's insurance plan, insurance carrier, and/or the type of disaster. In one embodiment, the method 400 generates 425 a notification for the user to diagnose the disaster and/or contact a repair service provider. In one embodiment, the method 400 automatically prepopulates 430 electronic forms, e.g., insurance forms, repair service provider contact forms, and/or the like, based on the user's information, the information about the disaster type, and/or the like. In one embodiment, the method 400 contacts 435 one or more repair service providers, e.g., in response to user input or automatically without user confirmation, and the method 400 ends.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a controller 106, such as a smart hub or a control panel of a home automation system, a sensor 114, a disaster apparatus 135, a disaster detection module 202, a disaster type module 204, an action module 206, a user's device, a mobile application, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
at least one sensor unit of a home automation system;
a processor; and
a memory that stores code executable by the processor to cause the apparatus to:
detect a disaster event using data captured by the at least one sensor unit;
determine a type of the disaster event based on the captured data;
identify at least one repair service provider associated with the determined type of disaster event; and
initiate contact with the at least one repair service provider for performing repairs associated with the disaster event.

2. The apparatus of claim 1, wherein the code is executable by the processor to cause the apparatus to identify the at least one repair service provider based on an approved list of repair service providers associated with an insurance carrier.

3. The apparatus of claim 1, wherein the code is executable by the processor to cause the apparatus to initiate contact with the at least one service provider by initiating a phone call, a text message conversation, an online chat, or a combination thereof.

4. The apparatus of claim 1, wherein the code is executable by the processor to present at least one interactive graphical user interface element to initiate contact with the at least one repair service provider.

5. The apparatus of claim 1, wherein the code is executable by the processor to cause the apparatus to determine a location for the disaster event and use the determined location to identify the at least one service provider.

6. The apparatus of claim 1, wherein the code is executable by the processor to cause the apparatus to determine contact information for the at least one repair service provider prior to initiating contact with the at least one repair service provider.

7. The apparatus of claim 6, wherein the code is executable by the processor to cause the apparatus to transmit the determined contact information for the at least one repair service provider to a user and provide means for contacting the at least one repair service provider.

8. The apparatus of claim 1, wherein the code is executable by the processor to cause the apparatus to present at least one question to a user to assess an extent of the disaster event.

9. The apparatus of claim 8, wherein the code is executable by the processor to cause the apparatus to present a plurality of instructions to the user for remedying the disaster event based on the user's response to the at least one question.

10. The apparatus of claim 1, wherein the code is executable by the processor to cause the apparatus to present educational diagnosis information to the user for assisting with the type of disaster event.

11. The apparatus of claim 10, wherein the educational diagnosis information comprises educational content for diagnosing and remedying the disaster event.

12. The apparatus of claim 10, the code is executable by the processor to cause the apparatus to present educational diagnosis information as part of a post-disaster follow-up at some time after the disaster event.

13. The apparatus of claim 1, wherein the code is executable by the processor to cause the apparatus to query at least one different sensor unit for different sensor data to confirm the disaster event, the at least one different sensor unit comprising a sensor unit proximate to the at least one sensor unit or a sensor unit of a same type as the at least one sensor unit.

14. The apparatus of claim 1, wherein the code is executable by the processor to cause the apparatus to prepopulate an electronic form provided by the at least one repair service provider with information associated with the disaster event.

15. The apparatus of claim 1, wherein the code is executable by the processor to access a data store of an insurance carrier or a home automation provider to identify the at least one repair service provider.

16. A method, comprising:
detecting a disaster event using data captured by at least one sensor unit;
determining a type of the disaster event based on the captured data;
identifying at least one repair service provider associated with the determined type of disaster event; and
initiating contact with the at least one repair service provider for performing repairs associated with the disaster event.

17. The method of claim 16, further comprising identifying the at least one repair service provider based on an approved list of repair service providers associated with an insurance carrier.

18. The method of claim 16, further comprising initiating contact with the at least one service provider by initiating a phone call, a text message conversation, an online chat, or a combination thereof.

19. The method of claim 16, further comprising presenting at least one interactive graphical user interface element to initiate contact with the at least one repair service provider.

20. An apparatus, comprising:
means for detecting a disaster event using data captured by the at least one sensor unit;
means for determining a type of the disaster event based on the captured data;
means for identifying at least one repair service provider associated with the determined type of disaster event; and
means for initiating contact with the at least one repair service provider for performing repairs associated with the disaster event.
